(19) United States
(12) Patent Application Publication
(10) Pub. No.: US 2009/0281933 A1
(43) Pub. Date: Nov. 12, 2009

(54) VALUE MANAGING DEVICE AND VALUE MANAGING METHOD

(75) Inventor: Nobuyuki Nonaka, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignees: Aruze Corp., Koto-ku, Tokyo (JP); Seta Corp., Koto-ku, Tokyo (JP)

(21) Appl. No.: 12/296,432

(22) PCT Filed: Apr. 20, 2007
(86) PCT No.: PCT/JP2007/058654

§ 371 Date: Oct. 8, 2008

(30) Foreign Application Priority Data
May 1, 2006 (JP) 2006-127762

(51) Int. Cl. G06Q 10/00; G06Q 50/00

(52) U.S. Cl. 705/30

(57) ABSTRACT

Numeral values relating to depletion can be managed in real time on a component-by-component (unit-by-unit) basis. A value managing device is provided, and manages the current asset values of constituent elements by reading identification information from IC tags or the like attached to constituent elements (e.g., components, units, parts) constituting a game-playing machine and storing identification information (e.g., part IDs) for uniquely identifying the constituent elements. The value managing device includes: a storage section storing the dates of acquisition and acquisition prices of the constituent elements in association with the identification information; and a value computing section for computing the current assets of the constituent elements from the dates of acquisition and acquisition prices of the constituent elements corresponding to the identification information read from the IC tags or the like.

### TECHNICAL FIELD

The present invention relates to a value managing device and method, and more particularly, to a value managing device and method which is capable of keeping track of an asset value according to a degree of use of components, units, and parts or the like, of game-playing machines and peripherals, if they are recycled and used.

### BACKGROUND ART

In recent years, there has been a growing demand for companies to take an environment into consideration. As part of the environmental consideration into which companies take, more and more companies have attempted to save resources and prevent environmental contamination due to wastes by taking recycling activities at the maximum. In order to utilize recycled wastes, it has been a common routine to re-collect sold or rented products or components thereof, and then, utilize them for the sake of manufacture of new products.

In the case where new products are manufactured by taking the recycling activities described above, re-collected products or components are repaired for the sake of reuse, and then, are maintained as inventory components. Such inventory components are handled as assets on business accounting. The re-collected products and components thereof have been commercially available for use in market, and thus, the durable period thereof becomes short in comparison with new products and components, and furthermore, an asset value should be reduced.

In a conventional business accounting system, however, such re-collected products and components are evaluated in accordance with a period, etc., during which they were used, and precise asset evaluation has not necessarily been made as to product inventory prices, component-inventory prices, or factory shipment prices by individual products.

### DISCLOSURE OF THE INVENTION

An object of the present invention is to manage numeric values associated with depletion in real time, on a component-by-component (unit-by-unit) basis, of game-playing machines and peripherals.

Another object of the present invention is to keep track of precise factory shipment prices on a product-by-product basis at the time of factory shipment, and thereafter, readily keep track of manufacturing cost in the manufacture of products employing recycled units. Still another object of the present invention is to readily keep track of inventory prices of new components and those of re-collected and recycled units.

As means for solving the abovementioned problems, the present invention has the following features.

An aspect of the present invention is proposed as a value managing device for managing current asset values of constituent elements by reading identification information from an identification information maintaining portion such as IC tags, barcodes, two-dimensional codes (such as QR codes (registered trademark of Denso Wave Co., Ltd.), Maxi codes, and DATA MATRIX, for example) attached to the constituent elements (such as components, units, and parts, for example) constituting a game-playing machine, the identification information maintaining portion recording identification information (part IDs) for uniquely specifying the constituent elements.

This value managing device is characterized by comprising: a storage portion (storage section, for example) storing dates of acquisition and acquisition prices of the constituent elements in association with the identification information; and a computing portion (value computing section) for computing current asset values of constituent elements, based upon the dates of acquisition and acquisition prices of the constituent elements corresponding to the identification information read from the identification information maintaining portion.

According to the value managing device, it becomes possible to manage the asset values of the constituent elements reflecting depletion on a component-by-component (unit-by-unit) basis of the game-playing machine.

It is preferable that the abovementioned value managing device store a total amount of depletion obtained from the date of acquisition of the constituent elements by the storage portion (storage section, for example), and thereafter, subtract the total amount of depletion from the acquisition prices of the constituent elements by the computing portion (value computing section, for example), thereby computing the current asset values of the constituent elements.

According to the value managing device, it becomes possible to manage the asset values of the constituent elements reflecting depletion on a component-by-component (unit-by-unit) basis of the game-playing machine.

It is preferable that the abovementioned managing device further include: a sending-in side reading portion (a sending-in side reader/writer, for example) for reading identification information from IC tags or the like attached to constituent elements if the game-playing machines or the constituent elements thereof are added to assets (at the time of sending-in an inventory or factory); a taking-out side reading portion (a taking-out side reader/writer, for example) for reading identification information from IC tags or the like attached to constituent elements if the game-playing machines or the constituent elements thereof are excluded from the assets; and a judging portion (a judging section, for example) for judging whether the constituent elements are added to or are excluded from the assets, wherein the current asset values of the constituent elements are calculated by the computing portion (value computing section, for example) in accordance with a result of the judgment obtained by the judgment portion.

According to the value managing device, it becomes possible to manage the asset values of the constituent elements reflecting depletion in real time, by a component-by-component (unit-by-unit) basis, of a game-playing machine which is taken-out, and thereafter, is sent-in, for the sake of recycling.

The abovementioned value managing device may include the asset values of the game-playing machine comprising the constituent elements by employing the current asset values of the constituent elements by the computing portion (the value computing section, for example).

According to the value managing device, as to the game-playing machines which are different from each other in asset value or in manufacturing cost due to use of components to be recycled, it is possible to keep track of exact factory shipment prices on a product-by-product basis at the time of factory shipment (including shipments at the time of shipment of new products and after recycled); to readily keep track of the manufacturing cost at the manufacture of products employing recycled units or asset values while they are in stock; and to readily keep track of the asset values including recycled components in stock.

The identification information maintaining portion, which the above-mentioned managing device reads, may read identification information by any reading portion or medium, and, for example, an IC tag which is wirelessly readable or a barcode (including a two-dimensional bar code) which is optically readable.

### BRIEF DESCRIPTION OF THE DRAWINGS

FIG. 1 is a view showing an overview of a value managing system according to the present embodiment;

FIG. 2 is a block diagram depicting an exemplary configuration of the value managing system according to the embodiment;

FIG. 3 is a functional block diagram of a value managing device according to the embodiment;

FIG. 4 is a view showing an exemplary value management table included in the value managing device according to the embodiment;

FIG. 5 is a view showing an exemplary amount-of-depletion table included in the value managing device according to the embodiment;

FIG. 6 is a view showing an exemplary value managing table updated by the value managing device according to the embodiment;

FIG. 7 is a view showing an exemplary value managing table updated by the value managing device according to the embodiment;

FIG. 8 is a view showing an exemplary value managing table updated by the value managing device according to the embodiment;

FIG. 9 is a view showing an exemplary value managing table updated by the value managing device according to the embodiment;

FIG. 10 is a view showing an exemplary game-playing machine-constituting component table generated by the value managing device according to the embodiment; and

FIG. 11 is a view showing an exemplary game-playing machine value table generated by the value managing device according to the embodiment.

### BEST MODE FOR CARRYING OUT THE INVENTION

Hereinafter, embodiments of the present invention will be described with referring to the accompanying drawings.

[1. Overview]

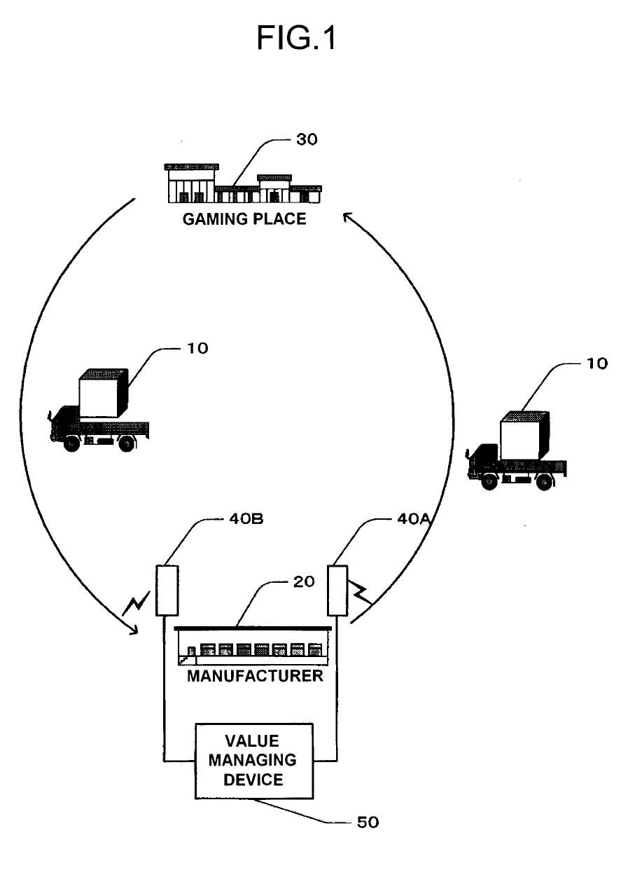

FIG. 1 is a view showing an overview of a value managing system according to the present embodiment.

A game-playing machine 10 is a machine which is disposed in a gaming place, such as a pachinko machine, a slot machine, or a video game machine, and provides games to players. The game-playing machine 10 is manufactured by assembling a plurality of units. These units are replaceable devices, units, or boards, and are inclusive of a liquid crystal display panel device, a reel unit, a hopper unit, and an image processing circuit board, for example. Wireless IC tags, which are identification information maintaining portions, are attached to the game-playing machine and its related units. The wireless IC tags mounted to the game-playing machine 10 and its related units are read by means of a reader/writer 40, thus allowing the reader/writer to detect which set of the game-playing machines 10 and units is taken-out from a manufacturer 20 or taken therein.

Hereinafter, a case in which the game-playing machine 10 was sold without rental will be described by way of example. A manufacturer 20 manages the game-playing machine 10 by assembling units to which the wireless IC tags were attached, for example. The manufactured game-playing machine 10 is sold in a gaming place 30. The game-playing machine 10 that the gaming place 30 bought is taken-out from the manufacturer 20 to the gaming place 30. The game-playing machine 10 is installed in the gaming place 30, is provided for players to play games, and then, is placed in an operable state.

After that, the game-playing machine 10 is discarded from the gaming place 30 by the virtue of a reason such as installation of new types of machines. The manufacturer 20 buys the discarded game-playing machine 10 from the gaming place 30 or accepts them without charge. The manufacturer 20 takes the used game-playing machine 10 that were bought or accepted, out of the gaming place 30 into one's own manufacturing facilities or inventories. From among the units included in the game-playing machine 10, those available for the manufacture of new game-playing machines 10 or those of which durable period has not elapsed are removed and used. In other words, the abovementioned units are recycled and used.

Before the game-playing machine 10 is taken-out from the manufacturer 20 into the gaming place 30, the game-playing machine 10 is handled as an inventory or an asset of the manufacture 20. After that, if the game-playing machine 10 is taken-out from the manufacturer 20 into the game-playing place 30, the game-playing machine 10 and units included therein are not handled as assets of the manufacturer 20. After that, if the manufacturer 20 accepts the game-playing machine 10 as a unit for recycling, the units of the game-playing machine 10 are handled as components for the manufacture of a new game-playing machine 10, or alternatively, as a newly manufactured game-playing machine 10, and become assets of the manufacturer 20.

The newly manufactured game-playing machine 10 with the used units incorporated therein is transported to the gaming place 30, if it is bought by the gaming place 30. After that, this game-playing machine 10 with the used units incorporated therein is taken-out from the gaming place 30 into the manufacturing works or inventories of the manufacturer 20. From among the units included in the game-playing machine 10, those available for the manufacture of a new game-playing machine 19 are removed; are repaired as required; and thereafter, are recycled and used.

The units of the game-playing machine 10 are thus repeatedly used and recycled, thereby allowing companies to implement management considering environment such as resource saving or reduction of industrial waste.

However, the units of the game-playing machine 10 are used ones, and therefore, their asset value decreases in comparison with that established when these units were new. The value managing device 50 can compute the asset values of the game-playing machine 10 and units such as a unit use count and a use period, based upon a result of reading of the wireless IC tag. This device can also keep track of the values of component inventories in the manufacturer in real time, thereby allowing companies to keep track of their asset values in real time.

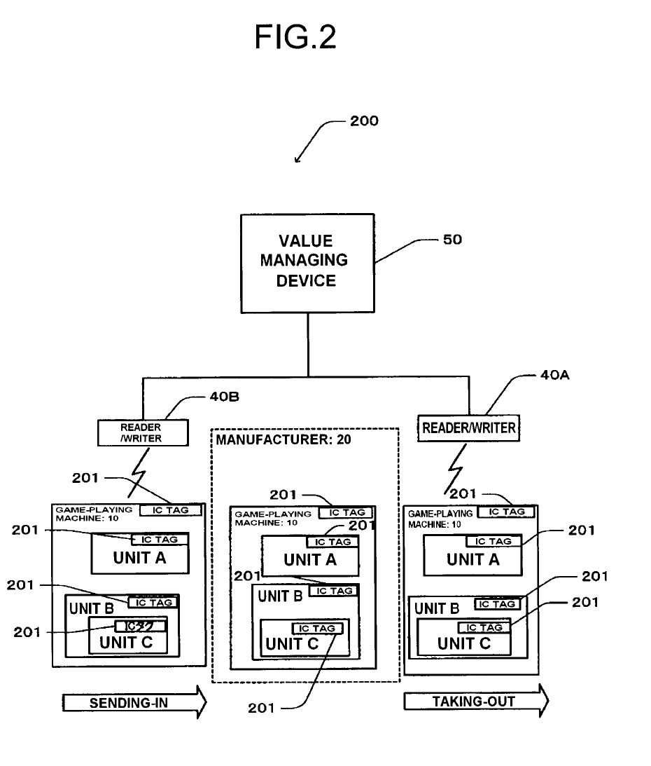

FIG. 2 is a block diagram depicting an exemplary configuration of a value managing system according to the present embodiment. A value managing system 200 has a value managing device 50 and readers/writers 40A, 40B connected thereto.

The value managing device 50 is a device which has: a central processing unit (CPU); a main memory (RAM); a read-only memory (ROM); an input/output device (I/O); and an external storage unit such as a hard disk drive unit, as required. Also, this device is an information processing device such as a computer or a workstation, for example. The value managing device stores: a program for causing the ROM or hard disk drive unit and the like to function as the value managing device 50, or alternatively, a program for causing a computer to execute a value managing method. This program is downloaded on the main memory, and the CPU executes it, whereby the value managing device 50 is implemented, or alternatively, the value managing method is executed. Further, the abovementioned program needs not to be always stored in a storage included in the information processing unit, and may be provided from an external device (such as a server of ASP (Application Service Provider), for example), so that the provided program is downloaded on the main memory.

The reader/writer 40 has a function of wirelessly reading the information stored in the IC tag from the IC tag, and then, posting the read information to the value managing device 50 (Hereinafter, the above reader/writer is referred to as readers/writers 40A, 40B, respectively, in order to discriminate a taking-out detection side reader/writer and a sending-in detection side reader/writer from each other. These readers/writers have the same features/functions.)

In the example shown in FIG. 2, a game-playing machine 10 is inclusive of three units, i.e., a unit A (a liquid crystal display unit, for example); a unit B (a reel unit, for example); and a unit C (a reel drive monitor, for example) or the like. The word “units” used in the present invention denotes devices, components, and constituent elements targeted for value management in this value managing system, without being limitative thereto. What sorts of components are handled as the units of the present invention is determined depending upon what sort of components are subject to value management. These components can be arbitrarily defined in accordance with the user's determination of a value managing system, and is not limitative depending upon physical equipment configuration or the like.

Incidentally, IC tags 201 are attached to the game-playing machine 10 and each of the units. In other words, the IC tags 201 are attached to the game-playing machine 10 and each of the units A, B, and C, respectively. In each of the IC tags, identification information, from which the respective IC tags can be uniquely specified, is stored so as to be readable by means of the reader/writer 40.

In a situation in which the game-playing machine 10 has not become an asset of the manufacturer 20, for example, when the game-playing machine 10 is taken-out from an inventory, and thereafter, is transported to the gaming place 30, each of the IC tags 201 that were attached to the game-playing machine 10 and units A, B, and C incorporated therein is read by means of the reader/writer 40A that was provided at an taking-out gate of the inventory. The value managing device 50 judges that the game-playing machine 10 and the units A, B, and C incorporated therein have not become assets of the manufacturer 20, based upon identification information of the read IC tags, and then, based upon the judgment, performs asset value processing.

On the other hand, in a situation in which the game-playing machine 10 has become an asset of the manufacturer 20, for example, when the game-playing machine 100 has been sent-in to an inventory, each of the IC tags 201 that were attached to this game-playing machine 10 and the units A, B, and C incorporated therein is read by means of the reader/writer 40B that was provided at a sending-in gate of the inventory. The value managing device 50 judges that the game-playing machine 10 and the units A, B, and C incorporated therein has become assets of the manufacturer 20, and then, based upon the judgment, performs asset value processing.

Further, the value managing device 50 has a function of performing depletion reflection processing, which is processing of reflecting an amount of depletion as to the asset value of each of the units, and then, keeping track of the residual value in real time.

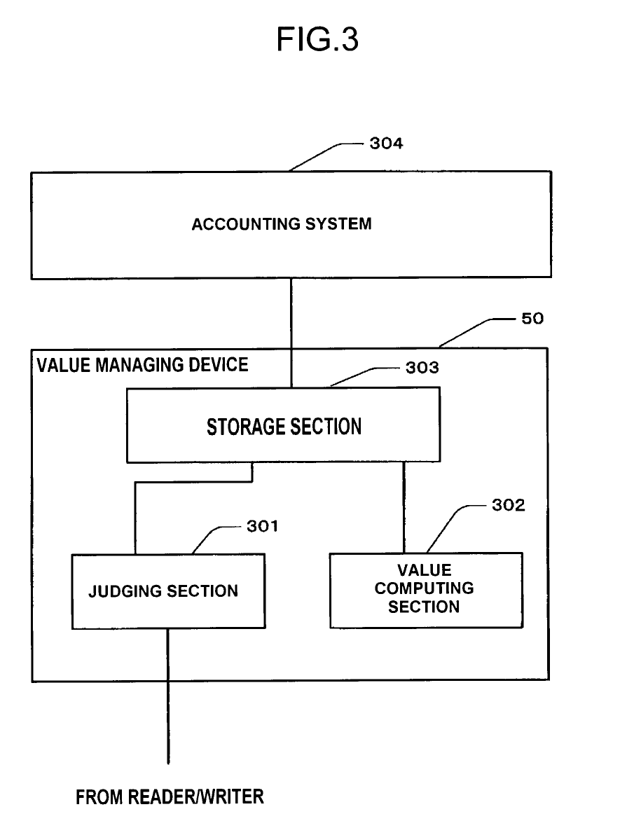

FIG. 3 is a functional block diagram depicting one example of the value managing device 50. The value managing device 50 has: a judging section 301, which judges whether the game-playing machine 10 and/or the units incorporated therein are removed from or added to the assets of the manufacturer 20, according to the identification information read from the readers/writers 40A, 40B; a value computing section 302, which computes the residual values and asset values of the game-playing machine 100 and the units incorporated therein; and a storage section 303, which stores the residual values and asset values of the game-playing machine 10 and/or the units incorporated therein, that were computed by means of the value computing section 302. Further, the value computing section 302 sums up the residual values of all of the units incorporated in each of the game-playing machines, and then, computes the value of the game-playing machine 10 (referred to as an “individual game-playing machine value”). The computed value of each of the game-playing machines 10 is stored by the storage section 303, and then, is utilized for computation of manufacturing cost or the like.

The residual values, the asset values, and the individual game-playing machine values, all of which were stored in the storage section 303, can be utilized by an accounting system 304 connected to the value managing device 50. The accounting system 304 utilizes the residual value and the asset value, both of which were stored in the storage section 303 for the preparation of documents such as a balance sheet (B/S) and a profit-and-loss statement, thereby allowing more precise financial statement to be reflected in these documents.

Further, the accounting system 304 can compute the manufacturing cost of the game-playing machine, by utilizing the individual game-playing machine values stored in the storage section 303.

[2. Exemplary Operation of the Value Managing Device]

Next, an exemplary operation of the value managing device 50 will be described.

[2.1. Operation when a New Game-Playing Machine is Completed]

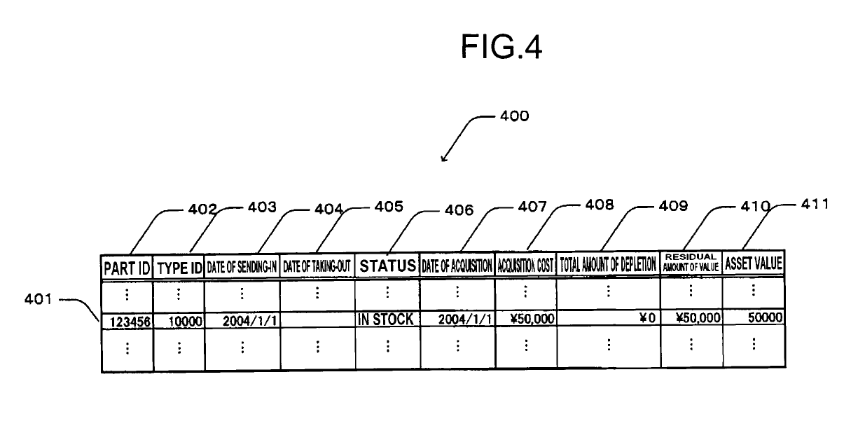

First, when a new game-playing machine 10 with new units incorporated therein is stored in an inventory of the manufacturer 20 while it is on standby for shipment, the value managing device 201 stores a value managing table 400 as shown in FIG. 4.

The value management table 400 is for storing: data to be stored in the storage section 303, i.e., identification information stored in the IC tag 201 attached to each of the units; and the residual value and asset value of each of the units to which the IC tags were attached.

The value management table 400 has one record 401 for each unit, and each record 401 has: a part-ID field 402; a type-ID field 403; an sending-in date field 404; a date-of-taking-out field 405; a status field 406; a date-of-acquisition field 407; an acquisition cost field 408; a total-amount-of-depletion field 409; a residual-amount-of-value field 410; and an asset value field 411.

The part-ID field 402 is a field for storing a part ID that is information for uniquely specifying the units to which the IC tags 201 were attached. The IC tags 201 may store the part IDs, or alternatively, may store identification information which was defined so that identification information and part ID of the ID tag 201 are established in a one-to-one relationship.

The type-ID field 403 is a field for storing a type ID that is information for specifying a type of unit of that record 401. For example, while, if two reel units exist, individual part IDs are set for these two reel units, the type IDs are identical to each other, since these reel units are identical to each other in type.

The date-of-taking-out field 405 is a field for storing a date when the units corresponding to the record 401 are sent-in to the manufacturer 20, and then, become assets of the manufacturer.

The date-of-taking-out field 405 is a field for storing a date when the units corresponding to the record 401 are taken-out from the manufacturer 20, and then, are excluded from the assets of the manufacture 20.

The status field 406 is a field for storing store status information which is indicative of whether or not the units corresponding to the record 401 become assets of the manufacturer 20. This status information is determined by the judging section 301 by comparing information of the sending-in date field 404 and the taking-out date field 405.

The date-of-acquisition field 407 is for storing a date when the units were newly acquired (for example, a date when the units were newly purchased and not a date when they were acquired as a recycle).

The acquisition cost field 408 is for storing an acquisition price (purchase prices of the units, for example) which is a price grounded for depletion of the units.

The total-amount-of-depletion field 409 is for storing a total amount of depletion that occurred from the date of acquisition up to now.

The residual-amount-of-value field 410 is for storing an asset value of the units at a current time point, i.e., an amount obtained by subtracting a total amount of depletion from the acquisition cost.

The asset value field 411 is for storing information according to whether or not the asset values of the units are included in the assets of the manufacture 20. In this example, if it is judged that they are included therein, the value equal to that stored in the residual-amount-of-value field 410 is stored, and, if it is not, 0 Yen is stored.

In the example shown in FIG. 4, there is shown a value management table 400 having a record 410 as to a new unit incorporated in a game-playing machine 10. This unit was purchased on Jan. 1, 2004 by the manufacturer 20. In the part-ID field 402, part ID “123456” for uniquely specifying this unit is stored, and, in the part-ID field 402, type ID “10000”, which is information for specifying a type of this unit (reel unit, for example), is stored. In the date-of-taking-out field 404, a date when this unit was sent-in to the manufacturer 20 (date when components are purchased) “2004/1/1” is stored. The date-of-taking-out field 405 is blanked because this unit was not taken-out from the manufacturer. In the status field 406, status information of “in stock”, which is representative of the fact that this unit is an asset of the manufacturer 20, is stored. In the date-of-acquisition field 407, “2004/1/1”, which is the date of acquisition of this unit, is stored. In the acquisition cost field 408, “50,000 Yen”, which is an acquisition cost (purchase price) of this unit, is stored. In the total-amount-of-depletion field 409, “0 Yen” is stored because no depletion occurred yet. In the amount-of-asset-value field 410, “50,000 Yen”, which is obtained by subtracting “0 Yen” from the acquisition cost “50,000 Yen”, is stored. In the asset value field 411, “50,000 Yen”, which is the same as that of the amount-of-asset value field, is stored because this unit is an asset of the manufacturer 20.

Items of data stored in this record are those of default data, and are not automatically input from the value managing device 50. In general, these items of data are generated by transferring data based upon purchase data or the like, or alternatively, are generated by an operator inputting them based upon documents or the like provided at the time of purchase.

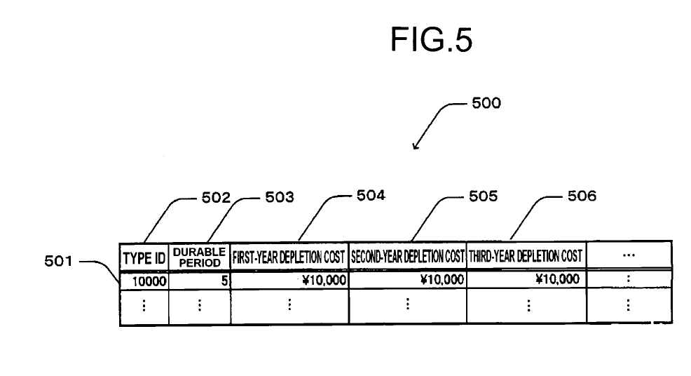

The storage section 303 has an amount-of-depletion table for determining a total amount of depletion in addition to the value management table 400. FIG. 5 shows an exemplary amount-of-depletion table. The amount-of-depletion table has one record 501 for each type ID, and each record 501 has: a type-ID field 502; a durable-period field 503; a first-year depletion cost field 504; a second-year depletion cost field 505; a third-year depletion cost field 506; . . . . The number-of-depletion field is defined in accordance with duration. For example, if the durable period is 5 years, that record 501 has the first-year depletion cost field 504 to the fifth-year depletion field. In the example shown in FIG. 5, although the contents corresponding to depletion using the age-life method are shown, needless to say, the present embodiment is established even if the depletion table corresponding to the age-life method is employed.

In the type-ID field 502, a type ID common to that in the type-ID field 403 of the value managing table 400 is employed. The value computing section 302 makes search for a record 501 having the same type ID, from the amount-of-depletion table 500 while the type ID of the type ID field 403 is employed as a key when a total amount of depletion is stored in the total-amount-of-depletion field 409 of the value managing table 400; computes a total amount of depletion with referring to the durable-period field 503, the first-year depletion cost field 504, the second-year depletion cost field 505, the third-year depletion cost field 506, . . . of the record 501; and stores the computed total amount in the total-amount-of-depletion field 409 of the value managing table 400.

[2.2. Operation when a New Game-Playing Machine is Taken-Out]

Next, an operation of the value managing device 50, when a game-playing machine 10 having the above units is sold to the gaming place 30, and then, is taken-out from the manufacturer 20, will be described.

Presuppose that the game-playing machine 10 with the abovementioned units incorporated therein passed through a location in which the reader/writer 40A detecting taking-out had been provided. The reader/writer 40A, which detects taking-out, sends identification information from an IC tag read for the value managing device 50. The value managing device 50 updates the value management table 400, based upon the identification information received from the reader/writer 40A.

One game-playing machine 10 has a plurality of units, and in other words, a plurality of IC tags 201 are read by means of the reader/writer 40A that detects taking-out. In other words, the value managing device 50 specifies the corresponding record 401 of the value management table 400 by identification information read from each ID tag 201.

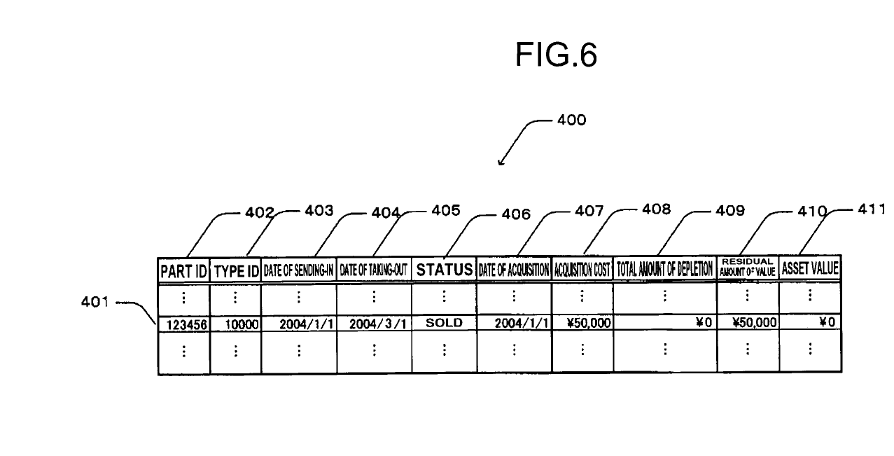

FIG. 6 shows an exemplary value management table 400 updated by means of the value managing device 50 at the time of taking-out the game-playing machine 10 having incorporated therein the units corresponding to the record 401 of the value management table 400 of FIG. 4.

In the example shown in FIG. 6, the value managing device 50, more particularly, the judging section 301, specifies the record 401, based upon the identification information received from the reader/writer 40A, and then, updates information of the date-of-taking-out field 405 of the thus specified record 40A, based upon a timer or calendar of the value managing device 50. In this example, a date when taking-out was implemented is presupposed to be Mar. 1, 2004 (2004/3/1). Updating of the date-of-taking-out field 404 is not performed.

Further, the value managing device 50, more particularly, the judging section 301, compares the date-of-sending-in field 404 with the date-of-taking-out field 405, and then, based upon a result of the comparison, updates information of the status field 406. In this example, the date stored in the date-of-taking-out field 405 is later than that stored in the date-of-sending-in field 404, and thus, the value managing device 50, more particularly, the judging section 30 stores information of “Sold” in the status field 406.

Further, the value managing device 50, more particularly, the value computing section 302, updates the total-amount-of depletion field 409. The value managing device 50, more particularly, the value computing section 302, compares the current date acquired from a timer or calendar of the value managing device 50 with that stored in the date-of-acquisition field 407; computes the total amount of depletion at the current time point; and stores the computed total amount in the total-amount-of-depletion field 409. Specifically, the value managing device 50, more particularly, the value computing section 302 acquires a total amount of depletion from the aforementioned amount-of-depletion table 500 (see FIG. 5) while the type ID stored in the type-ID field 403 is employed as a key. For example, if the date of acquisition is one year ago or later and is earlier than two years ago in comparison with the current date, the value managing device 50, more particularly, the value managing section 302, acquires the value stored in the first-year depletion cost field 504 of the record 501 having the corresponding type ID, and then, stores the acquired value in the total-amount-of-depletion field 409. Further, if the date of acquisition is two years ago or later and is earlier than three years ago in comparison with the current date, the value managing device 50, more particularly, the value computing section 302, acquires the values stored in the second-year depletion cost field 505, sums up these values, and stores them in the total-amount-of-depletion field 409.

Furthermore, the value managing device 50, more particularly, the value computing section 302 updates the residual-amount-of-value field 410. In other words, the value managing device 50, more particularly, the value computing section 302 calculates an amount of a value obtained by subtracting a value stored in the total-amount-of-depletion field 409 from that stored in the acquisition-cost field 408, and then, stores it in the total-amount-of-depletion field 410.

Still furthermore, the value managing device 50, more particularly, the value computing section 302 updates the asset value field 411. In other words, the value managing device 50, more particularly, the value computing section 302 stores in the asset field 411 the value amount reflecting whether or not the constituent element becomes an asset, with referring to the information of the status field 406. In this example, information of “Sold”, which is indicative of the fact that the unit has not become the step, is stored in the status field 406, and thus, the value managing device 50, more particularly, the value computing section 302 stores 0 yen.

The value managing device 50 updates the record 401, as described above, as to all of the detected IC tags 201 by the reader/writer 40A, i.e., as to all of the units to which IC tags were attached.

[2.3. Operation when a Used Game-Playing Machine is Sent-In]

Next, an operation of the value managing device 50, in the case where the game-playing machine 10 having the above units is re-collected from the gaming place 30 by the manufacturer 20, and then, is sent-in to the manufacturer, will be described.

Presuppose that the game-playing machine 10 with the abovementioned units (units handled in FIGS. 5 and 6) incorporated therein passed through a location in which the reader/writer 40B, which detects sending-in, had been provided. The reader/writer, which detects taking-out, sends identification information from an IC tag read to the value managing device 50. The value managing device 50 updates the value management table 400, based upon the identification information received from the reader/writer 40B that detects taking-out.

Like the description of taking-out, one game-playing machine 10 has a plurality of units. In other words, a plurality of IC tags 201 included in the game-playing machine 10 is all read by means of the reader/writer 40B. The value managing device 50 updates the record 401 of the value management table 400 as to each of the IC tags 201. In other words, the value managing device 50 specifies the corresponding record 401 of the value management table 400 by the identification information read from each of the IC tags 201.

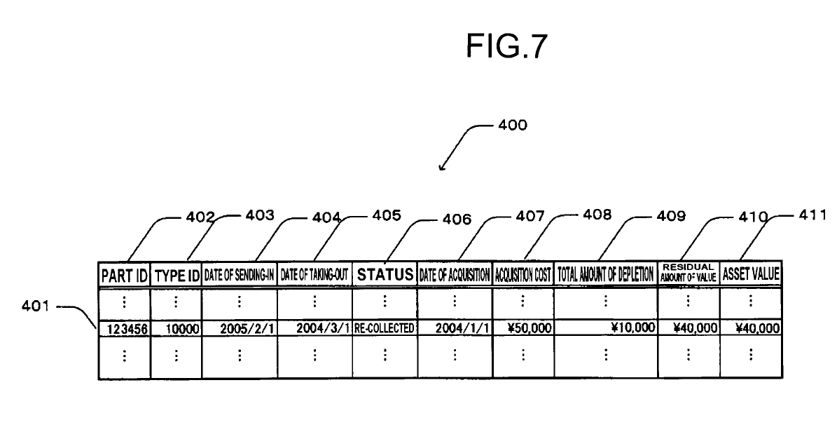

FIG. 7 shows an exemplary value managing table 400 updated by the value managing device 50 owing to sending-in of the game-playing machine 10 after used, having incorporated therein the units corresponding to the record 401 of the value management table 400 in FIGS. 4 and 6.

In the example shown in FIG. 7, the value managing device 50, more particularly, the judging section 301 specifies the record 401, based upon the identification information received from the reader/writer 40B; updates to the current date the information of the date-of-sending-in field 404 of the thus specified record 401, based upon the timer or calendar of the value managing device 50. In this example, the date when taking-out was implemented is defined as Feb. 1, 2005 (2005/2/1). On the other hand, updating of the date-of-taking-out field 405 is not performed.

The value managing device 50, more particularly, the judging section 301, compares the date-of-sending-in field 404 with the date-of-taking-out field 405, and then, based upon a result of the comparison, updates information of the status field 406. In this example, the date stored in the date-of-taking-out field 405 is earlier than that stored in the date-of-taking-out field 404, and thus, the value managing device 50, more particularly, the judging section 30 stores information of “Re-collected” in the status field 406.

Further, the value managing device 50, more particularly, the value computing section 302, updates the total-amount-of-depletion field 409. The value managing device 50, more particularly, the value computing section 302 compares the current date acquired from the timer or calendar of the value managing device 50 with that stored in the date-of-acquisition field 407; computes the total amount of depletion at the current time point; and updates it in the total-amount-of-depletion field 409. Specifically, the value managing device 50, more particularly, the value computing section 302 acquires the total amount of depletion from the abovementioned amount-of-depletion table 500 while the type ID stored in the type-ID field 403 is employed as a key. In the example of FIG. 7, the date of acquisition is one year ago or later and is earlier than two years ago in comparison with the current date, and thus, the value managing device 50, more particularly, the value computing section 302 acquires the value stored in the one-year depletion cost field of the record 501 having the corresponding type ID, and then, stores it in the total-amount-of-depletion field 409. In the example of FIG. 7, the value “10,000 Yen” stored in the one-year depletion cost field of the depletion table 500 shown in FIG. 5 is stored in the total-amount-of-depletion field 409.

Furthermore, the value managing device 50, more particularly, the value computing section 302 updates the residual-amount-of-value field 410. In other words, the value managing device 50, more particularly, the value computing section 302 computes an amount of the value obtained by subtracting the value stored in the total-amount-of-depletion field 409 from that stored in the acquisition cost field 408, and then, stores it in the residual-amount-of-value field 410. In the example of FIG. 7, the amount “40,000 Yen” obtained by subtracting the total amount of depletion “10,000 Yen” from the acquisition amount “50,000 Yen” is stored in the residual-amount-of-value field 410.

Furthermore, the value managing device 50, more particularly, the value computing section 302 updates the residual value field 410. In other words, the value managing device 50, more particularly, the value computing section 302 stores in the asset value field 411 the value reflecting whether or not the constituent element becomes an asset, with referring to the information of the status field 406. In this example, in the status field 406, information of “Re-collected, which is indicative of the fact that the constituent element becomes an asset, is stored, and thus, the value managing device 50, more particularly, the value computing section 302 stores “40,000 Yen” stored in the residual-amount-of-value field 410.

The value managing device 50 updates the record 401, as described above, as to all of the IC tags 201 that were detected by means of the reader/writer 40B, i.e., all of the units to which the IC tags were attached.

The value managing device 50 thus updates the value management table 400, whereby the units of the re-collected game-playing machine 10 can be kept track of as components for manufacturing new game-playing machines 10, i.e., as the company's assets, and the depletion cost can be reflected as to the asset value.

[2.4. Operation when a Recycled Game-Playing Machine is Taken-Out]

Next, an operation of the value managing device 50, when new game-playing machines 10, in which the abovementioned used units were incorporated (referred to as a recycled game-playing machine), are sold to the gaming place 30, and then, are taken-out from the manufacturer 20, will be described.

Presuppose that the recycled game-playing machine 10 with the abovementioned units incorporated therein passed through a location in which the reader/writer 40A, which detects taking-out, had been provided. The reader/writer 40A, which detects taking-out, sends identification information from an IC tag read for the value managing device 50. The value managing device 50 updates the value management table 400, based upon the identification information received from the reader/writer 40A.

One game-playing machine 10 has a plurality of units. In fact, a plurality of IC tags 201 is read by means of the reader/writer 40A that detects taking-out. The value managing device 50 updates the record 401 of the value managing table 400 as to each of the IC tags. In other words, the value managing device 50 specifies the corresponding record 401 of the value management table 400 by identification information read from each ID tag 201.

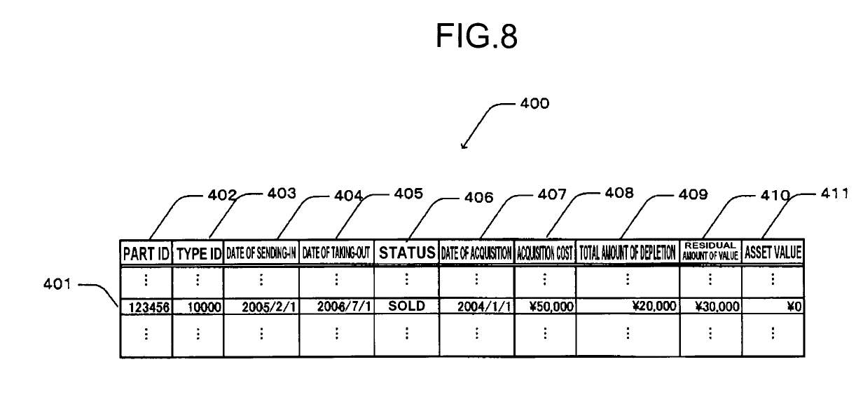

FIG. 8 shows an exemplary value management table 400, which was updated by means of the value managing device 50, at the time of taking-out of the game-playing machine 10 with its incorporated units corresponding to the record 401 of the value management table 400 of FIGS. 4, 6, and 7.

In the example shown in FIG. 8, the value managing device 50, more particularly, the judging section 301, specifies the record 401, based upon the identification information received from the reader/writer 40A, and then, updates information of the date-of-taking-out field 405 of the thus specified record 40A, based upon a timer or calendar of the value managing device 50. In this example, a date when taking-out was implemented is presupposed to be Jul. 1, 2006 (2006/7/1). Updating of the date-of-taking-out field 404 is not performed.

Further, the value managing device 50, more particularly, the judging section 301 compares the date-of-sending-in field 404 with the date-of-taking-out field 405, and then, based upon a result of the comparison, updates information of the status field 406. In this example, the date stored in the date-of-taking-out field 405 is later than that stored in the date-of-sending-in field 404, and thus, the value managing device 50, more particularly, the judging section 30 stores information of “Sold” in the status field 406.

Further, the value managing device 50, more particularly, the value computing section 302 updates the total-amount-of depletion field 409. The value managing device 50, more particularly, the value computing section 302 compares the current date acquired from a timer or calendar of the value managing device 50 with that stored in the date-of-acquisition field 407; computes the total amount of depletion at the current time point; and stores the computed total amount in the total-amount-of-depletion field 409. Specifically, the value managing device 50, more particularly, the value computing section 302 acquires the total amount of depletion from the aforementioned depletion table 500 while the type ID stored in the type-ID field 403 is employed as a key. In the example shown in FIG. 8, the date of acquisition is two years ago or later and is earlier than three years ago in comparison with the current date, and thus, the value managing device 50, more particularly, the value computing section 302, acquires the values stored in the two-year depletion cost field 505, sums up these values, and then, stores them in the total-amount-of-depletion field 409. In the example of FIG. 8, specifically, a total amount “20,000 Yen” is stored in the total-amount-of-depletion field 409, the total amount being obtained by summing up a value “10,000 Yen” stored in the first-year depletion cost field 504 of the total-amount-of-depletion field 500 shown in FIG. 5 and a value “10,000 Yen” stored in the second depletion cost field 505.

Furthermore, the value managing device 50, more particularly, the value computing section 302, updates the residual-amount-of-value field 410. In other words, the value managing device 50, more particularly, the value computing section 302, computes an amount of the value obtained by subtracting the value stored in the total-amount-of-depletion field 409 from that stored in the acquisition cost field 408, and then, stores it in the residual-amount-of-value field 410. In the example shown in FIG. 8, the amount of value “30,000 Yen” obtained by subtracting the total amount of depletion “20,000 Yen” from the acquisition price “50,000 Yen” is stored in the residual-amount-of-value field 410.

Furthermore, the value managing device 50, more particularly, the value computing section 302 updates the residual-amount-of-value field 410. In other words, the value managing device 50, more particularly, the value computing section 302 stores the value amount reflecting whether or not the constituent element becomes an asset, in the asset value field 411, with referring to the information of the status field 406. In this example, information of “Sold”, which is indicative of the fact that the constituent element has not become an asset, is stored in the status field 406, and thus, the value managing device 50, more particularly, the value computing section 302 stores 0 Yen.

The value managing device 50 updates the record 401 as described above as to all of the detected IC tags 201 by the reader/writer 40A, i.e., as to all of the units to which IC tags were attached.

[2.5. Operation when a Reduced Recycled Game-Playing Machine is Sent-In]

Next, an operation of the value managing device 50, when the recycled game-playing machine 10 sent to the gaming place 30 is re-collected from the gaming place 30 to the manufacturer 20, and then, is sent-in to the manufacturer 20, will be described.

Presuppose that the used, recycled game-playing machine 10 with the abovementioned units incorporated therein passed through a location in which the reader/writer 40B detecting sending-in had been provided. The reader/writer 40B sends identification information from the IC tag read at the value managing device 50. The value managing device 50 updates the value management table 400, based upon the identification information received from the reader/writer 40B detecting taking-out.

A used recycled game-playing machine 10 has a plurality of units. In other words, a plurality of IC tags 201 included in the game-playing machine 10 is all read by means of the reader/writer 40B detecting sending-in. The value managing device 50 updates the record 401 of the value management table 400 for each of the IC tags 201. In other words, the value managing device 50 specifies the corresponding record 401 of the value management table 400 by the identification information read from each of the IC tags 201.

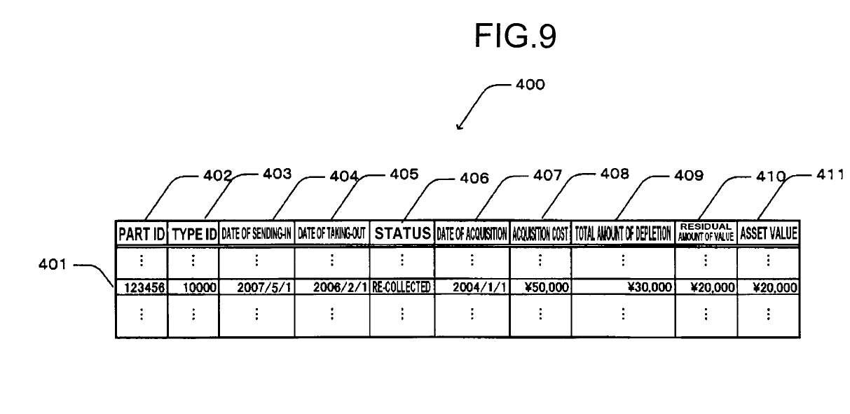

FIG. 9 shows an example of the value managing table 400 updated by the value managing device 50 owing to sending-in of the game-playing machine 10 after used, having incorporated therein the units corresponding to the record 401 of the value management table 400 of FIGS. 4, 6, 7, and 8.

In the example shown in FIG. 9, the value managing device 50, more particularly, the judging section 301 specifies the record 401, based upon the identification information received from the reader/writer 40B, and then, updates the information of the date-of-sending-in field 404 of the specified record 401, based upon the timer or calendar of the value managing device 50. In this example, the date when the used recycled game-playing machine 10 was sent-in is defined as May 1, 2007 (2007/5/1). On the other hand, updating of the date-of-taking-out field 404 is not performed.

Further, the value managing device 50, more particularly, the judging section 301 compares the date-of-sending-in field 404 with the date-of-taking-out field 405, and then, based upon a result of the comparison, updates information of the status field 406. In this example, the date stored in the date-of-taking-out field 405 is earlier than that stored in the date-of-sending-in field 404, the value managing device 50, more particularly, the judging section 30 stores information of “Re-collected” in the status field 406.

Furthermore, the value updating device 50, more particularly, the value computing section 302, updates the total-amount-of depletion-cost field 409. The value managing device 50, more particularly, the value computing section 302 compares the current date acquired from the timer or calendar of the value managing device 50 with that acquired in the date-of-acquisition field 407; computes the total amount of depletion at the current time point; and then, stores it in the total-amount-of-depletion field 409. Specifically, the value managing device 50, more particularly, the value computing section 302 acquires the total amount of depletion from the aforementioned amount-of-depletion table 500 while the type ID stored in the type-ID field 403 is employed as a key. In the example of FIG. 9, the date of acquisition is three years ago or later and is earlier than four years ago in comparison with the current date, and thus, the value managing device 50, more particularly, the value computing section 302 acquires the value stored in a respective one of the first-year, second year, and third-year depletion cost fields 504, 505, and 506 of the record 501 having its corresponding type ID, and then, stores them in the total-amount-of-depletion-cost field 506. In the example of FIG. 9, the total-amount-of-depletion field 409 stores “30,000 Yen” which is a total amount of “10,000 Yen” stored in the first-year depletion cost field 504, “10,000 Yen” stored in the second-year depletion cost field 505, and “10,000 Yen” stored in the third-year depletion cost field 506.

Still furthermore, the value managing device 50, more particularly, the value computing section 302 updates the residual-amount-of-value field 410. In other words, the value managing device 50, more particularly, the value computing section 302 computes the amount of the value obtained by subtracting the value stored in the total-amount-of-depletion field 409 from that stored in the acquisition-cost field 408, and then, stores it in the residual-amount-of-value field 410. In the example of FIG. 9, the residual-amount-of-value field 410 stores “20,000 Yen” obtained by subtracting the total amount of depletion “30,000 Yen” from the acquisition cost “50,000 Yen”.

Yet furthermore, the value managing device 50, more particularly, the value computing section 302 updates the asset value field 411. In other words, the value managing device 50, more particularly, the value computing section 302 stores in the asset value field 411 the amount of value reflecting whether or not the constituent element becomes an asset, with referring to the information of the status field 406. In this example, in the status field 406, information of “Recollected”, which is indicative of the fact that the constituent element becomes an asset, is stored, and thus, the value managing device 50, more particularly, the value computing section 302 stores, in the asset value field, “20,000 Yen” which was stored in the residual-amount-of-value field 410.

In this manner, it is possible to keep track of the fact that units corresponding to this record 401, the units having “20,000 Yen” as an asset value on which depletion was reflected, became assets of the manufacturer 20.

The value managing device 50 updates the record 401, as described above, as to all of the IC tags 201 that were detected by means of the reader/writer 40B, i.e., all of the units to which the IC tags were attached. With the value managing system 200 and/or the value managing device 50, according to the embodiment, therefore, it becomes possible to keep track of the asset value reflecting depletion in real time as to all of the units included in the used reflected game-playing machine 10 that were sent-in (limitative to the units to which IC tags were attached).

In this manner, the value managing device 50 updates the value management table 400, whereby the units of the re-collected game-playing machine 10 can be kept track of as components for manufacturing a new game-playing machine 10 or as assets of a manufacturer, and the depletion cost reflected as to the asset value can be reflected.

[3. Managing Asset Value of the Game-Playing Machine]

The abovementioned value managing device 50 is capable of managing the asset values of the game-playing machines 10, respectively. For example, the asset value of a game-playing machine completely comprised of new units and that of the game-playing machine 10 employing used recycled units should be handled differently in consideration of the depletion of the used units. The value managing device 50 manages the asset values of the game-playing machines 10, respectively, by employing the abovementioned value management table 400.

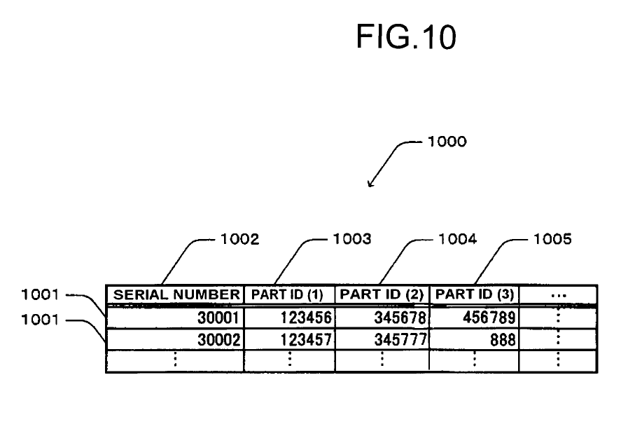

FIG. 10 shows an exemplary game machine-constituting component table which is generated by the value managing device 50 in order to manage the asset values of the game-playing machines 10, respectively. A game-playing machine-constituting component table 1000 is a table for storing serial numbers that are items of information for uniquely specifying the game-playing machine 10 and the units included in the game-playing machine 10 in association with each other. In the example shown in FIG. 10, the game-playing machine-constituting component table 1000 has one record 1001 for each game-playing machine 10. Each record 1001 has a serial number field 1002 and part-ID fields 1003, 1004, 1005, . . . . The serial number field 1002 is for storing identification information stored in the IC tag 201 attached to the game-playing machine 10 or information corresponding thereto, for example, game-playing machine serial numbers or game-playing machine ID numbers. The part-ID fields 1003, 1004, 1005, . . . are fields for storing components IDs of the units that constitute the game-playing machine 10. In general, components ID fields 1003, 1004, 1005, . . . for the number of units included in the game-playing machine 10 are provided. Part IDs employed in the game-playing machine-constituting component table 1000 are commonly employed in the part-ID field 402 of the value managing table 400.

If the game-playing machines 10 are read by means of the reader/writer 40B (which may be 40A or any other reader/writer) on a one-by-one machine basis, reading of the IC tags 201 attached to the units constituting the game-playing machines 10 is also performed at the same time as reading of the IC tag 201 attached to the game-playing machine 10. Therefore, items of identification information of the IC tags, which could be read at the same time, are stored in one record 1001 in association with one another, whereby the value managing device 50 generates the game-playing machine-constituting component table 1000.

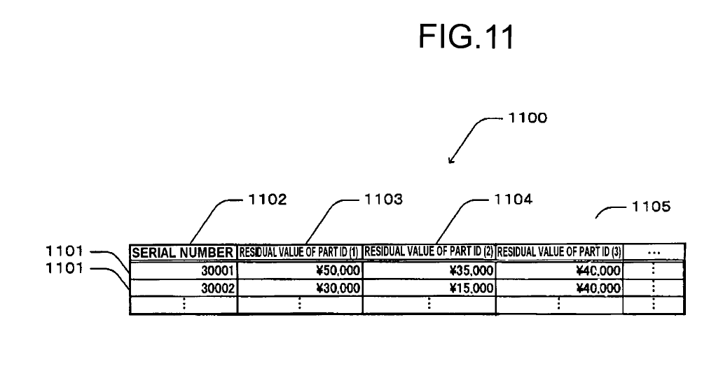

Further, the value managing device 50 generates a game-playing machine value table 1100 for keeping track of the asset value of each of the game-playing machines 10, based upon the game-playing machine-constituting component table 1000. FIG. 11 is a view showing an exemplary game-playing machine value table 1100. In the example shown in FIG. 11, the game-playing machine value table 1100 has one record 1101 for each game-playing machine 10. Each record 1101 has a serial number field 1102 and component-residual-amount-of-value fields 1103, 1104, 1105, . . . .

The serial number field 1102 stores identification information stored in the IC tag 201 attached to the game-playing machine 10 or information corresponding thereto, for example, game-playing machine serial numbers or game-playing machine ID numbers. Common identification information is used in the serial number field 1002 of the game-playing machine-constituting component table 1000 and the serial number field 1102 of the game-playing machine value table 1100.

The value managing device 50 samples, from the game-playing machine-constituting component table 1000, the record 1001 having the serial number field 1002 storing identification information that is identical to that included in the serial number field 1102, and then, acquires a part ID from each of the part-ID fields of the sampled record 1001. Next, the value managing device 50 samples, from the value management table 400, the record 401 having the part ID that corresponds to the acquired part ID; acquires the residual amounts of values from the residual-amount-of-value field 410 of the sampled record 401; and stores them in the component-residual-amount-of-value fields 1103, 1104, 1105, . . . . By way of this processing, the value managing device 50 generates the game-playing machine value table 1100.

By summing up the residual amounts of values in the component-residual-amount-of-value fields 1103, 1104, 1105, . . . of each record 1101, the value of the game-playing machine 10 specified by the identification information of the serial number field 1102 can be kept track of as a value reflecting depletion.

According to the value managing device 50 for generating such game-playing machine value table 1100, it becomes possible to manage depletion arising due to recycling/reuse while such depletion is individually reflected on products, although it has been conventionally impossible to do so.

The present specification is based upon Japanese Patent Application No. 2006-127762 filed on May 1, 2006, the entire contents of which are incorporated therein.

### INDUSTRIAL APPLICABILITY

As described above, the value managing device and method according to the present invention is provided, and manages current asset values of constituent elements by reading an identification information maintaining portion assigned to the constituent elements constituting a game-playing machine, the portion storing identification information for uniquely specifying the constituent elements; stores a date of acquisition and an acquired amount of value of the constituent elements in association with the abovementioned identification information; and computes the current asset values of the constituent elements, based upon the date of acquisition and the acquired amount of value of the constituent elements, corresponding to the identification information read from the identification information maintaining portion, thereby allowing asset values to be managed in consideration of depletion as to components (units) in a case of manufacturing a new game-playing machine by employing components (units) of a recyclable game-playing machine. Therefore, the value managing device and method has industrial applicability.

1. A value managing device, which manages current asset values of constituent elements by reading an identification information maintaining portion assigned to the constituent elements constituting a game-playing machine, the maintaining portion storing identification information for uniquely specifying the constituent elements, said device comprising:
a storage portion for storing dates of acquisition and acquired amounts of values of the constituent elements in association with the identification information; and
a computation portion for computing current asset values of the constituent elements, based upon the dates of acquisition and the acquired amounts of values of the constituent elements, corresponding to the identification information read from the identification information maintaining portion.

2. The value managing device according to claim 1, wherein: the storage portion stores a total amount of depletion obtained from the dates of acquisition of the constituent elements; and the computation portion computes the current asset values of the constituent elements by subtracting the total amount of depletion from the acquired amounts of values of the constituent elements.

3. The value managing device according to claim 2, further comprising:
a sending-in side reading portion for reading the identification information from the identification information maintaining portion assigned to the constituent elements if the game-playing machine and at least one of constituent elements thereof are incorporated in assets;
a taking-out side reading portion for reading the identification information from the identification information maintaining portion assigned to the constituent elements if the game-playing machine and at least one of constituent elements thereof are removed from asset; and
a judgment portion for receiving the identification information from the sending-in side reading portion and a taking-out side reading portion and judging whether or not the constituent elements are included in assets,
wherein the computation portion computes current asset values of the constituent elements, according to a result of the judgment by the judgment portion.

4. The value managing device according to claim 3, wherein the computation portion computes a current asset value of the game-playing machine comprising the constituent elements, using the current asset values of the constituent elements.

5. The value managing device according to claim 1, wherein the identification information maintaining portion is any of an IC tag, a barcode, and a two-dimensional code.

6. A value managing method of managing current asset values of constituent elements by reading an identification information maintaining portion assigned to the constituent elements constituting a game-playing machine, the maintaining portion storing identification information for uniquely specifying the constituent elements, said method comprising the steps of:
storing dates of acquisition and acquired amounts of values of the constituent elements in association with the identification information; and
computing current asset values of the constituent elements, based upon the dates of acquisition and the acquired amounts of values of the constituent elements, corresponding to the identification information read from the identification information maintaining portion.

7. The value managing method according to claim 6, comprising the step of storing a total amount of depletion obtained from the dates of acquisition of the constituent elements, wherein the current asset values of the constituent elements are computed by subtracting the total amount of depletion from the acquired amounts of values of the constituent elements.

8. The value managing method according to claim 7, further comprising the steps of:
reading the identification information from the identification information maintaining portion assigned to the constituent elements if the game-playing machine and at least one of constituent elements thereof are incorporated in assets;
reading the identification information from the identification information maintaining portion assigned to the constituent elements if the game-playing machine and at least one of constituent elements thereof are removed from assets; and
judging whether or not the constituent elements are included in assets in accordance with the identification information read when the constituent elements are added to assets and are removed therefrom,
wherein current asset values of the constituent elements are computed, according to a result of the judgment by the judgment portion.

9. The value managing method according to claim 8, wherein a current asset value of the game-playing machine comprising the constituent elements is computed using current asset values of the constituent elements.
